(19) United States
(12) Patent Application Publication
(10) Pub. No.: US 2013/0243498 A1
(43) Pub. Date: Sep. 19, 2013

(54) DEVELOPING DEVICE, PROCESS CARTRIDGE, AND IMAGE FORMING APPARATUS

(71) Applicant: CANON KABUSHIKI KAISHA, Tokyo (JP)

(72) Inventors: Hisashi Taniguchi, Suntou-gun (JP); Yoshihiro Mitsui, Numazu-shi (JP); Shinya Yamamoto, Numazu-shi (JP)

(73) Assignee: CANON KABUSHIKI KAISHA, Tokyo (JP)

(21) Appl. No.: 13/798,546

(22) Filed: Mar. 13, 2013

(30) Foreign Application Priority Data
Mar. 19, 2012 (JP) 2012-061724
Jan. 25, 2013 (JP) 2013-011989

(51) Int. Cl. G03G 15/08

(52) U.S. Cl. CPC G03G 15/0818
USPC 399/284; 399/286

(57) ABSTRACT

A developing apparatus for an image forming apparatus, the developing apparatus comprising a developer carrying member for carrying a developer to develop an electrostatic latent image formed on an image bearing member; and a regulating member contacted to the developer carrying member to regulate a layer thickness of the developer on the developer carrying member, wherein the developer carrying member includes a surface layer having a storage modulus E′ satisfying 15 Pa≦E′≦30 Pa, the regulating member includes an free end having a curved surface to define a space with the surface layer to provide an entrance for the developer, and the curved surface has a radius of curvature R satisfying 100 μm≦R≦500 μm.

### FIELD OF THE INVENTION AND RELATED ART

The present invention relates to an image forming apparatus, such as a copying machine and a printer, which uses an electrophotographic image forming method or electrostatic recording method. It also relates to a developing device and a process cartridge, with which an image forming apparatus is equipped.

An image forming apparatus such as a copying machine or a printer has been known to use an electrophotographic image formation process. To concretely describe an electrophotographic image formation process, the peripheral surface of a rotatable photosensitive drum is uniformly charged with the use of a charging means such as a charge roller. Then, an electrostatic latent image is formed on the uniformly charged area of the peripheral surface of the photosensitive drum by exposing the uniformly charged area of the peripheral surface of the photosensitive drum to a beam of laser light or the like.

Meanwhile, a film-thin layer of developer is formed on the peripheral surface of a development roller. Then, the photosensitive drum bearing the electrostatic latent image and the development roller are rotated relative to each other, with the peripheral surface of the photosensitive drum being kept in contact with the developer layer on the development roller, while development bias is applied to the development roller. Thus, the developer on the development roller transfers onto the peripheral surface of the photosensitive drum, in the pattern of the electrostatic latent image. That is, the electrostatic latent image is developed into a visible image, which is an image formed of the developer (which hereafter may be referred to as “toner image”).

Thereafter, the toner image is transferred onto recording medium in the transfer station of the image forming apparatus. Then, the toner image on the recording medium is fixed to the recording medium with the application of heat and pressure, in the fixation station of the apparatus, ending the process of forming an image on the recording medium. Then, the recording medium is discharged from the main assembly of the image forming apparatus.

Some of the developing devices which are used to supply the peripheral surface of a photosensitive drum with developer are structured as follows: the developer container for storing developer is provided with an opening, and the development roller is positioned in the developer container in such a manner that it virtually completely plugs the opening by being partially exposed from the container, and also, that its peripheral surface opposes the peripheral surface of the photosensitive drum.

The developer container contains a toner supply roller for supplying a development roller with developer, and a development blade for forming a film-thin layer of developer on the peripheral surface of the development roller. The development blade is positioned so that it contacts the peripheral surface of the development roller by the portion which is immediately adjacent to its upstream edge in terms of the rotational direction of the development roller, for example, the portion which is roughly 0.1-5.0 mm from the upstream edge. As the development roller is rotated, the development blade forms the developer supplied to the peripheral surface of the development roller by the developer supply roller, into a film-thin layer of developer, which is uniform in thickness.

The development roller employed by a developing device is an elastic roller, which is roughly the same in electrical resistance as semiconductor. It is kept pressed upon the photosensitive drum. Further, a development blade and a toner supply roller are kept pressed upon the development roller. During an image forming operation, electrical voltage is applied to the development roller. As the amount of stress to which toner is subjected by the development roller exceeds a certain value, the toner (developer) becomes welded to the peripheral surface of the development roller, sometimes causing thereby the image forming apparatus to output an image which has unwanted lines which are parallel to the recording medium conveyance direction and correspond in position to the portions of the peripheral surface of the development roller, to which the toner (developer) has become welded. Hereafter, this phenomenon will be referred to as “toner filming.” As one of the solutions to “toner filming”, Japanese Laid-open Patent Application 2005-141192 proposes a development roller which is substantially smaller in the amount of stress to which a development roller subjects toner, than a conventional development roller.

The development roller disclosed in Japanese Laid-open Patent Application 2005-141192 has a shaft (as core of roller), an electrically conductive elastic layer which wraps around the peripheral surface of the shaft, and an electrically conductive surface layer which covers the outward surface of the electrically conductive elastic layer. The electrically conductive surface layer contains polyurethane formed by polymerizing polyurethane-polyol prepolymer, with the use of isocyanate compound.

Its electrically conductive surface layer is significantly less in surface hardness than a conventional development layer. Therefore, it is significantly smaller in the amount of stress to which it subjects toner than a conventional development roller, and therefore, is far less likely to cause “toner filming”.

However, simply reducing a development roller in the surface hardness of its electrically conductive layer as proposed in Japanese Laid-open Patent Application was problematic in that it allows a development blade to dig into the development roller (developer bearing member), and therefore, it reduces the amount by which developer is coated on the peripheral surface of the development roller.

### SUMMARY OF THE INVENTION

The present invention was made to solve the above-described problem. Therefore, its primary object is to enable a developer bearing member to bear a proper amount of developer, without causing the “toner filming”.

According to an aspect of the present invention, there is provided a developing apparatus for an image forming apparatus, said developing apparatus comprising a developer carrying member for carrying a developer to develop an electrostatic latent image formed on an image bearing member; and a regulating member contacted to said developer carrying member to regulate a layer thickness of the developer on said developer carrying member, wherein said developer carrying member includes a surface layer having a storage modulus E′ satisfying 15 Pa≦E′≦30 Pa, said regulating member includes an free end having a curved surface to define a space with said surface layer to provide an entrance for the developer, and said curved surface has a radius of curvature R satisfying 100 μm≦R≦500 μm.

These and other objects, features, and advantages of the present invention will become more apparent upon consideration of the following description of the preferred embodiments of the present invention, taken in conjunction with the accompanying drawings.

### BRIEF DESCRIPTION OF THE DRAWINGS

FIG. 1 is a schematic sectional view of an image forming apparatus equipped with a developing device which is in accordance with the present invention.

FIG. 2(a) is an enlarged sectional view of the developer bearing member and developer layer thickness regulating member of the developing device in accordance with the present invention, and shows the structure of the development roller and developer layer thickness regulating member. FIG. 2(b) is a sectional drawing of the area of contact between the developer bearing member and developer layer thickness regulating member, and shows the radius of curvature of the developer layer thickness regulating member.

FIG. 3(a) is a table which shows the relationship between the storage modulus E′ of the surface layer of the developer bearing member and the occurrence of the “toner filming”. FIG. 3(b) is a table which shows the relationship among the radius R of curvature of the regulating portion of the developer layer thickness regulating member, the storage modulus E′ of the surface layer of the developer bearing member, and the amount by which developer was borne on the developer bearing member per unit area.

FIG. 4 is a graph which shows the relationship among the radius R of curvature of the regulating portion of the developer layer thickness regulating member, the storage modulus E′ of the surface layer of the developer bearing member, and the amount by which the developer was borne on the developer bearing member per unit area.

FIG. 5(a) is a table which shows the relationship between the radius R of curvature of the regulating portion of the developer layer thickness regulating member, the storage modulus E′ of the surface layer of the developer bearing member, and the occurrence of the “toner filming”. FIG. 5(b) is a table which shows the relationship among the storage modulus E′ of the surface layer of the developer bearing member, the surface roughness Ra of the electrically conductive surface layer of the developer bearing member, and the performance of the developer layer thickness regulating member.

FIG. 6 is a graph which shows the relationship between the surface roughness Ra of the developer bearing member which was 21 in storage E′, and the amount by which developer was coated on the developer bearing member immediately after the formation of a solid “white” image and a solid “black” image.

FIG. 7 is an enlarged sectional view of an example of modified version of the developer layer thickness regulating member.

### DESCRIPTION OF THE PREFERRED EMBODIMENTS

### (Embodiment 1)

First, a developing device in accordance with the present invention is concretely described along with a process cartridge and an image forming apparatus, which are equipped with a developing device in accordance with the present invention.

### <Image Forming Apparatus>

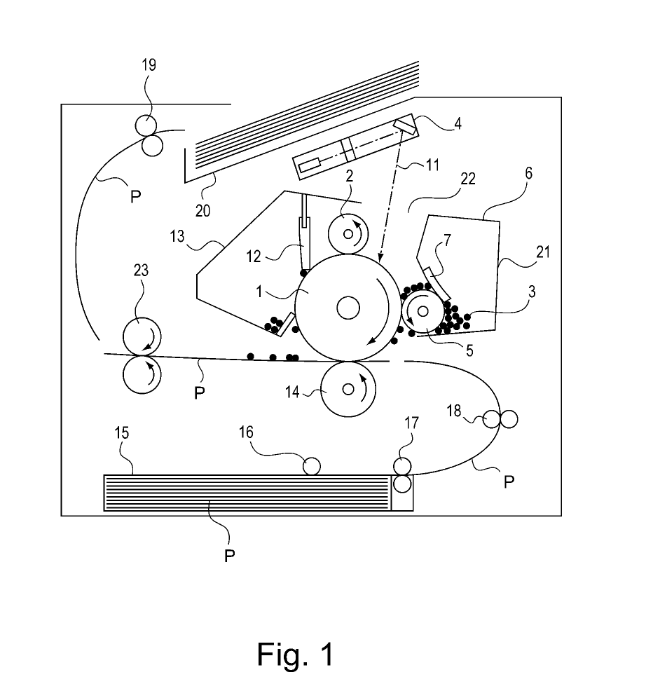

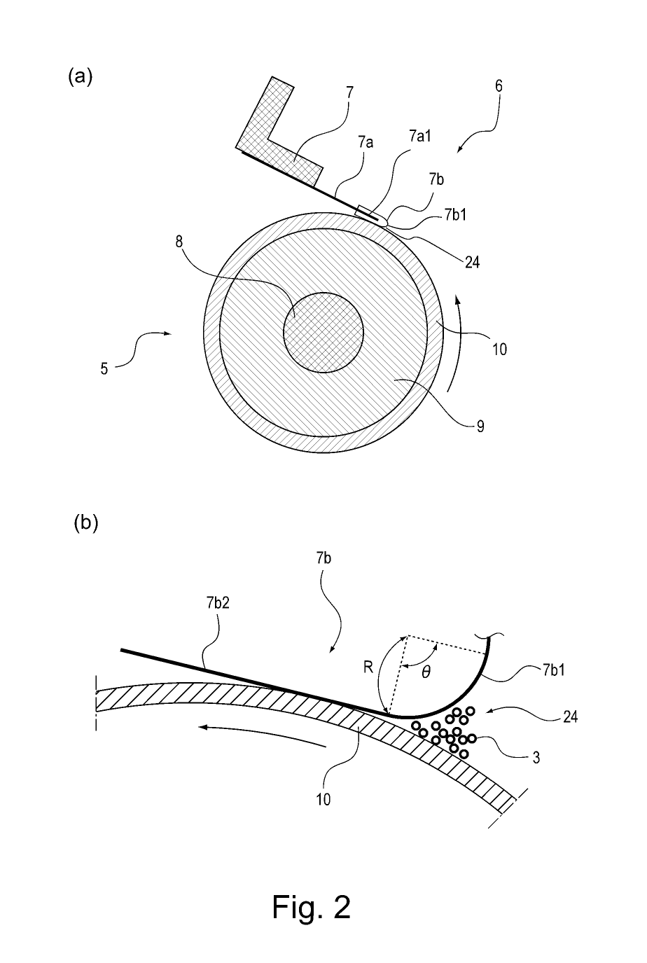

First, referring to FIGS. 1 and 2, a developing device in accordance with the present invention, and an image forming apparatus equipped with the developing device in accordance with the present invention, are described about their general structure. FIG. 1 is a schematic sectional view of the image forming apparatus in the first embodiment of the present invention. It shows the general structure of the apparatus.

The image forming apparatus in this embodiment is an electrophotographic image forming apparatus. More specifically, it is a laser printer. It is structured so that a process cartridge 21 which contains a developing device can be removably installable in its main assembly. However, this embodiment of the present invention, which will be described hereafter, is not intended to limit the present invention in terms of the type of a developing device to which the present invention is to be applied, and also, the type of an image forming apparatus to which the present invention is to be applied, although this embodiment is one the preferable embodiments of the present invention.

Referring to FIG. 1, a numerical referential code “1” stands for an electrophotographic photosensitive member which is in the form of a rotatable drum (photosensitive drum). The photosensitive drum is an organic photosensitive member which is negatively chargeable. It is rotationally driven by an unshown motor at a preset peripheral velocity in the clockwise direction which is indicated by an arrow mark in FIG. 1.

As the photosensitive drum 1 is rotated, its peripheral surface is negatively and uniformly charged by a charge roller 2 (as charging means) to a preset potential level. The charging device in this embodiment is of the contact type. That is, the charge roller 2 in this embodiment is placed in contact with the peripheral surface of the photosensitive drum 1, and is rotated by the rotation of the photosensitive drum 1. To the charge roller 2, a preset charge bias (electrical voltage) is applied from an unshown charge bias power source, in order to uniformly charge the peripheral surface of the photosensitive drum 1.

After the uniform charging of the peripheral surface of the photosensitive drum 1, it is exposed by an exposing device 4, which is for forming an electrostatic latent image on the uniformly charged portion of the peripheral surface of the photosensitive drum 1. In this embodiment, the exposing device 4 is a scanner which employs a semiconductor laser. More specifically, the exposing device 4 outputs a beam 11 of laser light while modulating the beam 11 with image formation signals sent from an unshown host apparatus which is in connection to the image forming apparatus, in such a manner that the outputted beam 11 of laser light scans (exposes) the uniformly charged portion of the peripheral surface of the photosensitive drum 1, through an exposure window 22 with which the process cartridge 21 is provided. As a given point of the uniformly charged portion of the peripheral surface of the photosensitive drum 1 is exposed, its potential level reduces in absolute value compared to an unexposed point. Thus, as the uniformly charged portion of the peripheral surface of the photosensitive drum 1 is scanned (exposed) by the beam 11 of laser light, an electrostatic latent image which reflects the information of the image to be formed, is effected on the peripheral surface of the photosensitive drum 1, with the progression of the exposure.

Then, the electrostatic latent image is developed by a developing device into a visible image, that is, a toner image, on the peripheral surface of the photosensitive drum 1. Then, the toner image is transferred by a transfer roller 14 (as transferring means) onto a sheet P of recording medium, such as paper, sent from a recording medium feeder cassette.

To describe more concretely the process of feeding and conveying of the sheet P of recording medium, the pickup roller 16 and sheet conveyance roller 17, with which the recording medium feeder cassette 15 is provided, are rotationally driven with a preset control timing. As they are driven, the topmost of the multiple sheets P of recording medium stored in layers in the cassette 15 is fed into the main assembly of the image forming apparatus, while being separated from the rest of the sheets P in the cassette 15. Then, the sheet P is conveyed to a pair of registration rollers 18, in synchronism with the formation of the toner image on the peripheral surface of the photosensitive drum 1. Then, the sheet P is conveyed to the nip between the photosensitive drum 1 and transfer roller 14, by the registration rollers, with such a timing that it arrives at the nip at the same time as the leading edge of the toner image on the peripheral surface of the photosensitive drum 1. A combination of the pickup roller 16, sheet conveyance roller 17, registration rollers 18, etc., makes up the conveying means for conveying the sheet P.

In this embodiment, a transferring device of the contact type, which uses the transfer roller 14, is used. The transfer roller 14 is kept in contact with the peripheral surface of the photosensitive drum 1 by the pressure applied to the transfer roller 14 toward the axial line of the photosensitive drum 1 by a pressure applying means such as a pair of compression springs.

As the sheet P of recording medium arrives at the nip between the photosensitive drum 1 and transfer roller 14, a transfer process is started, in which positive transfer bias is applied to the transfer roller 14 from the unshown transfer bias power source, whereby the negatively charged toner 3 on the peripheral surface of the photosensitive drum 1, of which the toner image on the peripheral surface of the photosensitive drum 1 is made up, is transferred onto the sheet P of recording medium.

After the transfer of the toner image onto the sheet P of recording medium, the sheet P is separated from the peripheral surface of the photosensitive drum 1, and is introduced into a fixing device 23 (as fixing means), in which the toner image is fixed to the sheet P. The fixing device 23 turns the unfixed toner image on the sheet P into a permanent image (fixed image) by the application of heat and pressure.

After the separation of the sheet P from the peripheral surface of the photosensitive drum 1, the peripheral surface of the photosensitive drum 1 is cleaned by the cleaning device 13 (residual toner on the peripheral surface of the photosensitive drum 1 is scraped away by the cleaning device 13) to be prepared for the next image formation. The cleaning device 3 in this embodiment employs a cleaning blade 12, which is for recovering the transfer residual toner, that is, the toner having failed to transfer from the peripheral surface of the photosensitive drum 1 onto the sheet P during the transfer process. The cleaning blade 12 is kept in contact with the peripheral surface of the photosensitive drum 1 by a preset amount of pressure to clean the peripheral surface of the photosensitive drum 1 by recovering the transfer residual toner. After the completion of the cleaning process by the cleaning blade 12, the cleaned portion of the peripheral surface of the photosensitive drum 1 is charged again by the charge roller 2.

After being put through the nip between the peripheral surface of the photosensitive drum 1 and transfer roller 14, the sheet P of recording medium is separated from the peripheral surface of the photosensitive drum 1, and is introduced into the fixing device 23, in which the unfixed toner image on the sheet P is fixed to the sheet P (welded to sheet P) by the heat and pressure applied by the fixing device 23. After the sheet P is conveyed out of the fixing device 23, it is discharged by a pair of discharge rollers 19 into an external delivery tray 20 of the image forming apparatus.

The image forming apparatus in this embodiment forms an image by sequentially carrying out the charging, exposing, developing, transferring, fixing, and cleaning processes with the use of the above described means, respectively.

### <Developing Device>

Next, referring to FIG. 2, the structure of the developing device in this embodiment is described.

The developing method used by the developing device in this embodiment is the so-called developing method of the contact type. In the case of this developing method, developer is borne on the peripheral surface of a development roller 5 (as developer bearing member) for developing an electrostatic latent image on the peripheral surface of the photosensitive drum 1, and is conveyed to the interface between the peripheral surface of the photosensitive drum 1 and the peripheral surface of the development roller 5, while a development bias, which is a DC voltage, is applied to the development roller 5 from an unshown development bias power source. The development roller 5 is rotationally driven in the counterclockwise direction indicated by an arrow mark in FIG. 1, at a peripheral velocity which is equivalent to 400 rpm.

The function of the development roller 5 is to convey nonmagnetic single-component polymer toner having a preset amount of electrical charge, to the peripheral surface of the photosensitive drum 1. The developer layer thickness regulating member 7 regulates in thickness the toner (developer) layer on the peripheral surface of the development roller 5 (developer bearing member), by being placed in contact with the peripheral surface of the development roller 5 while the toner (developer) layer is conveyed to the area of contact between the developer layer thickness regulating member 7 and the peripheral surface of the development roller 5. Further, it negatively charges the toner 3 in the area of contact between itself and the peripheral surface of the development roller 5. The thus formed thin layer of the toner 3 is supplied to the electrostatic latent image on the peripheral surface of the photosensitive drum 1, in the area of contact between the photosensitive drum 1 and development roller 5, to reversely develop the electrostatic latent image on the photosensitive drum 1.

### <Developer Bearing Member>

FIG. 2(a) shows the structure of the development roller 5. From the standpoint of making the present invention very effective, the external diameter of the development roller 5 is desired to be in a range of 10-30 mm. In this embodiment, the development roller 5 is 15 mm in external diameter.

Further, the shaft 8 (core) of the development roller 5 is metallic (metallic core 8), which is a solid or hollow cylinder made of an electrically conductive substance such as metal, and is 8 mm in external diameter. The metallic core 8 is rotationally driven by a motor with which the main assembly of the image forming apparatus is provided. The development roller 5 has a base layer 9 which is elastic and electrically conductive, and a surface layer 10, in addition to the metallic core 8. The base layer 9 covers the peripheral surface of the metallic core 8. The primary ingredient of the material for the base layer 9 is silicone rubber. In terms of the hardness in Asker C scale, the base layer 9 formed primarily of silicone rubber is desired to be in a range of 15°-70°, preferably, 20°-60°.

The surface layer 10 is on the outward facing surface of the base layer 9. It is made of a substance different in properties from the one of which the base layer 9 is made. In this embodiment, it is formed of polyurethane obtained by polymerizing polyurethane-polyol (pre-polymer) with the use of isocyanate.

Polyurethane-polyol (pre-polymer) is made by cross-linking polyether-polyol having two radicals, with isocyanate having two radicals. Its weight average molecular weight is in a range of 10,000-50,000. As for its degree of molecular weight dispersion, Mw/Mn≦3.0, Mz/Mw≦2.5. This kind of polyurethane-polyol (pre-polymer) is contained in the above-mentioned polyurethane by 70%-95% in mass “Mn” in the abovementioned degree of molecular dispersion is numerical average molecular weight obtainable by dividing the total in molecular weight of all molecules by the number of molecules. “Mn” is weight average molecular weight obtainable by dividing the total of the products of molecular weight of each molecule and weight of each molecule (proportional to molecular weight), by the overall weight. Further, “Mz” is z-average molecular weight obtainable by dividing the totaling of the products of the square of the molecular weight of each molecule and the weight of each molecular (proportional to molecular weight), by the total of the products of the molecular weight and weight.

Using a substance, the polyurethane-polyol (prepolymer) content of which is within the abovementioned range, as the material for the surface layer 10 makes it possible to produce a development roller 5 that is excellent in toner conveyance function, and yet, is low in hardness. More concretely, the softer surface layer 10, that is, surface layer 10, the storage modulus E′ of which is no less than 15 Pa and no more than 30 Pa, can be obtained by adjusting the material for the surface layer 10, in the amount and/or weight average molecular weight of polyurethane-polyol pre-polymer. With the use of this method, it is possible to reduce the amount of stress to which toner is subjected by the developer layer thickness adjusting member, in order to minimize the occurrence of “toner filming”.

### <Developer Layer Thickness Regulating Member>

Next, the structure of the developer layer thickness regulating member 7 of the developing device 6 in this embodiment is described.

The developer layer thickness regulating member 7 of the developing device 6 in this embodiment is made up of a blade portion 7a, and a film portion 7b which covers the developer layer thickness regulating edge portion of the blade portion 7a. The film portion 7b is formed primarily of electrically conductive resin or elastomer, and covers the blade portion 7a at least from the contact surface 7a1 of the blade portion 7a to the edge (7b1) of the blade portion 7a.

Because of the above-described structural arrangement, it is possible to provide the regulating portion 7b1 of the developer layer thickness regulating member 7 with a preset amount of curvature. That is, in terms of the cross-sectional view, the regulating portion 7b1 is curved. The developer layer thickness regulating member 7 is 10⁶Ω in volume resistivity. Referring to FIG. 2(b), the radius R of curvature of the regulating portion 7b1 of the developer layer thickness regulating member 7 in this embodiment is in a range of 100 μm-500 μm (100 μm≦R≦500 μm). Further, the central angle θ of the regulating portion 7b1 is no less than 90°. The space between the curved surface 7b1 (regulating portion) and the surface layer 10 serves a trap 24 for temporarily collecting the toner 3.

In this embodiment, the regulating portion 7b1 of the developer layer thickness regulating member 7 was formed of electrically conductive resin or elastomer. However, this embodiment is not intended to limit the present invention in terms of the material for the regulating portion 7b1 of the developer layer thickness regulating member 7. It is the contact surface 7b2, which is the flat portion of the developer layer thickness regulating member 7, that is in contact with the surface layer 10 of the development roller 5.

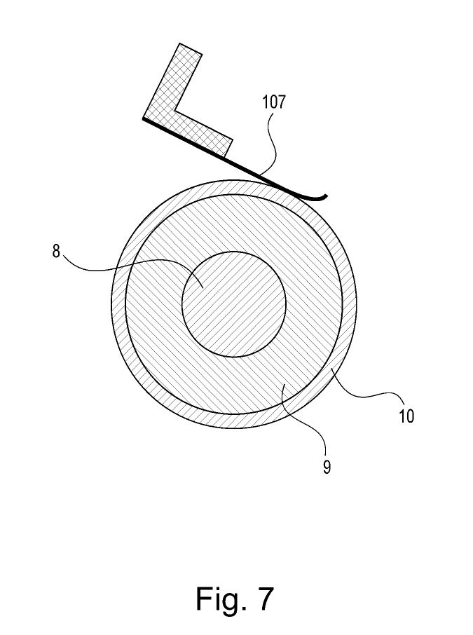

For example, a metallic blade or the like, the developer regulating portion of which was given the preset curvature by an edge bending process, can be used in place of the developer layer thickness regulating member 7 in order to get the same effect as that of the development layer thickness regulating member 7 in this embodiment. That is, a developer layer thickness regulating member 107, shown in FIG. 7, which was formed by pressing a flat piece of metallic plate so that its developer regulating portion is given the preset curvature, can be used in place of the developer layer thickness regulating member 7 in this embodiment.

In order to ensure that the amount by which developer is borne on the peripheral surface of the developer bearing member remains stable, it is desired that the developing device 6 is structured so that the amount of the contact pressure P between the developer thickness regulating portion of the developer layer thickness regulating member 7 and the peripheral surface of the developer bearing member falls within a range of 0.1-0.4 N/cm in liner pressure.

The actual method used to measure the amount of the linear pressure P is as follows: a piece of plate, which is 10.0 cm in length and 1.5 cm in width, was formed of flat and thin SUS plate which was 30 μm in thickness. This piece of plate was used as the first plate, which is to be pinched by the second plate. Further, another piece of plate, which is 18 cm in length and 3 cm in width, was formed of SUS plate which was the same in properties as the one of which the first plate was formed. This piece of plate was folded in half to pinch the first plate between its two halves. Then, the first plate was pinched by the second plate, and the combination of the first and second plates was inserted into the interface between the development roller 5 and photosensitive drum 1. Then, a spring scale was attached to one end of the first plate. Then, the first plate was pulled out from between the two halves of the second plate at a preset speed while measuring the amount of force necessary to pull the first plate out. Then, the amount of force necessary to pull the first plate out was divided by 1.5 cm, which is the width of the first plate, to obtain the amount of force, in terms of linear force [N/cm] to pull the first plate out.

### <Toner>

Next, the developer (toner) used by the developing device 6 in this embodiment is described. The toner used by the developing device 6 in this embodiment is nonmagnetic single-component developer manufactured by an emulsion polymerization. It is frictionally chargeable to negative polarity. It is 6 μm in volume average particle diameter. It contains a dielectric external additive, which is silicone oxide (silica particles), and an electrically conductive external additive, such as titanium oxide, aluminum oxide, zinc oxide, cerium oxide, tin oxide, and strontium titanate. Toner may contain at least one (one or combination of two or more) among these additives. The external additive which the toner used by the developing device 6 in this embodiment contained was a titanium oxide particulate.

The average particle size of the toner is desired to be in a range of 5-8 μm, and the softening point of the toner is desired to be no less than 60° C.

### <Verification 1>

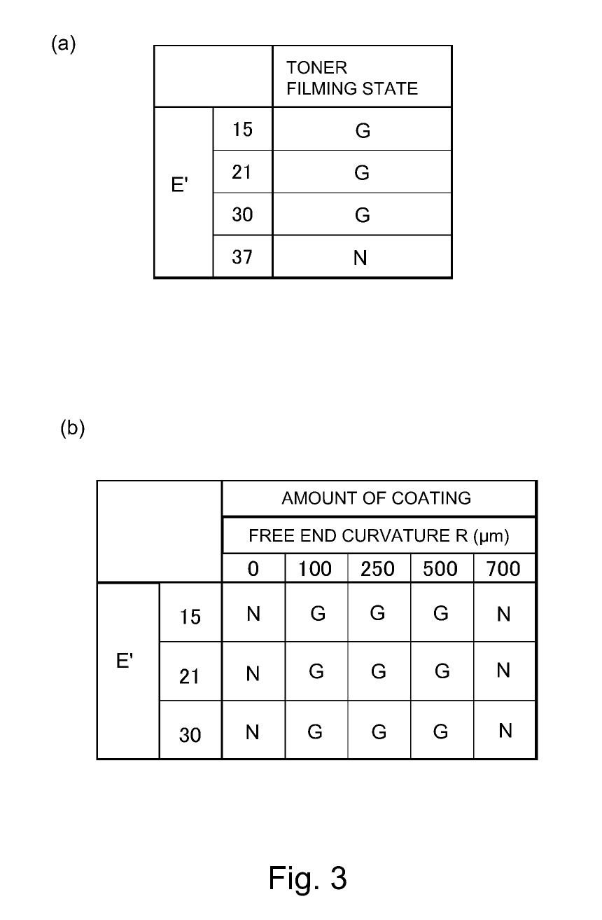

First, referring to FIG. 3(a), the effect of the storage modulus E′ of the surface layer 10 of the development roller 5 upon the occurrence of “toner filming” is described. The inventors of the present invention carried out experiments to verify the effect of the softening of the surface layer 10 of the development roller 5 upon the toner 3, in terms of the reduction in the amount of stress to which the toner 3 is subjected by the development roller 5.

In these experiments, three development rollers, the storage modulus E′ of the surface layer 10 which (measured in unit of Pa: Pascal) was in a range of 15-30 (15≦E′≦30), were tested. More specifically, the three development rollers were 15, 21 and 30, respectively, in storage E′. The storage E′ was measured with the use of a dynamic elasticity measurement apparatus, with the vibration frequency and temperature set to 10 Hz and 20° C., respectively. In addition, a development roller, the storage modulus E′ of the surface layer 10 of which was 37, was prepared as a comparative development roller. The four development rollers were combined with a straight developer layer thickness regulating member 7, that is, a development layer thickness regulating member which was 0 in radius R of curvature of the developer layer thickness regulating portion (R=0 μm). The four development rollers were tested for durability by continuously forming 20,000 images which had horizontal lines and were 1% in image ratio, in low temperature/low humidity (L/L) environment, which was 15° C. in temperature and 30% in relative humidity.

FIG. 3(a) shows the results of the verification. “G” means that the “toner filming” did not occur, and “N” means that “toner filming” occurred. The comparative development roller, the surface layer 10 of which was 37 in storage E′, always caused “toner filming”. In the case where the development rollers, the storage modulus E′ of the surface layer 10 of the development roller 5 was within a range of 15-30 (15≦E′≦30), the amount of the “toner filming” was not as much as in the case of the development roller which was 37 in storage E′. Thus, it was confirmed that the employment of a developer roller 5, the surface layer 10 of which is relatively soft is effective to reduce the amount of stress to which the toner 3 is subjected. Incidentally, in the case where the development roller 5 which is no more than 15 in storage E′ (E′<15) of its surface layer 10, it is difficult to adjust the development roller 5 in volume resistivity during the manufacturing of the development roller 5. Therefore, it is not suitable for mass production. That is, a development roller, the surface layer 10 of which is no more than 15 in storage E′ (E′≦51) is not practical.

### <Verification 2>

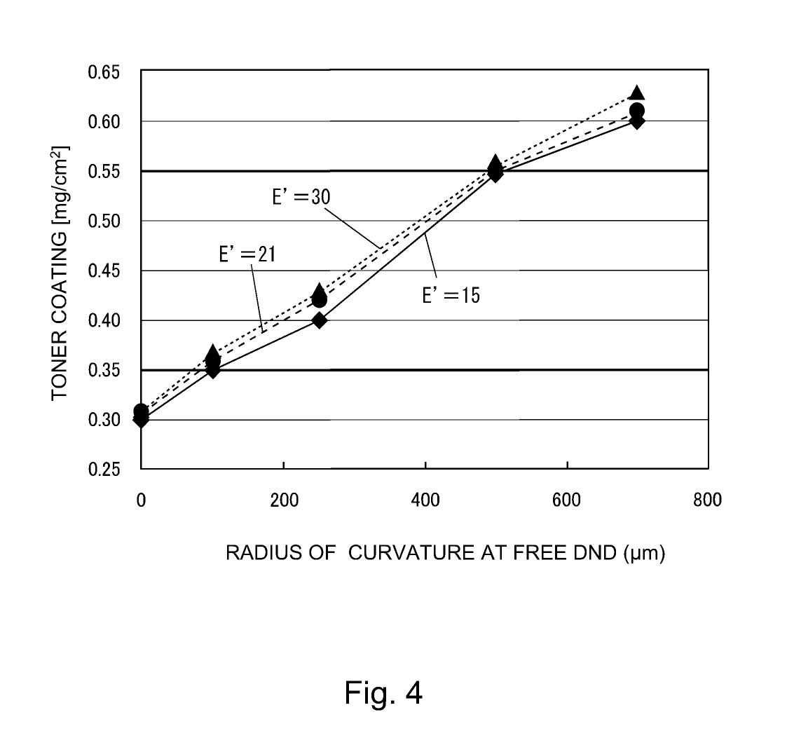

Next, referring to FIGS. 3(b) and 4, the relationship between the radius R of curvature of the developer regulating portion 7b1 of the developer layer thickness regulating member 7, and the amount by which the toner was coated on the surface layer 10 of the development roller 5 is described. Referring to FIG. 3(b), “G” means that the amount by which the toner was coated was proper, and “N” means that amount by which the toner was coated was unsatisfactory. In order to find out the abovementioned relationship, experiments were carried out in a high temperature/high humidity (H/H) environment, which was 35° C. in temperature and 90% in relative humidity (Rh). The results of the experiments were evaluated based on the same standard as that used for the evaluation of the results of the experiments carried out for the first verification. Also in these experiments, in a case where the storage modulus E′ of the surface layer 10 of the development roller 5 was within a range of 15-30 (15≦E′≦30), the “toner filming” did not occur. However, measuring the amount of toner per unit area of the surface layer 10 of the development roller 5 revealed that the developer layer thickness regulating member 7, the developer regulating portion 7b1 of which is zero in radius R of curvature, that is, the straight developer layer thickness regulating member 7, was smaller in the amount of toner per unit area on the surface layer 10 of the development roller 5.

The exhaustive examination of the results of these experiments by the inventors of the present invention revealed that in a high temperature/high humidity (H/H) environment, the soft surface layer 10 of the development roller 5 becomes softer, and therefore, it was easier for the developer regulating portion 7b1 of the developer layer thickness regulating member 7 to be made to dig into the surface layer 10 of the development roller 5, in the nip between the surface layer 10 of the development roller 5 and the developer regulating portion 7b1 of the development roller 5, by the pressure from the base portion of the developer layer thickness regulating member 7. Therefore, the aforementioned developer (toner) trap 24 (toner collecting portion, which is wedge-shaped in cross section in terms of rotational direction of development roller 5), which is formed by the surface layer 10 of the development roller 5 and developer layer thickness regulating member 7, tends to become narrower. Therefore, the amount, per unit area, by which toner is coated on the surface layer 10 of the development roller 5 reduced.

Thus, the inventors deduced as follows: in order to reduce the amount by which the developer regulating portion 7b1 of the developer layer thickness regulating member 7 digs into the surface layer 10 of the development roller 5, the inventors of the present invention provided the developer regulating portion 7b1 of the developer layer thickness regulating member 7 with a preset amount of curvature. With the provision of this curvature, it is difficult for the developer regulating portion 7b1 to dig into the surface layer 10 of the development roller 5, and therefore, the wedge-shaped developer (toner) trap 24 formed by the surface layer 10 of the development roller 5 and the developer layer thickness regulating member 7 tends to become larger, making it mechanically possible for the toner to be coated on the surface layer 10 of development roller 5 by a greater amount.

Thus, the inventors carried out experiments to find out whether or not the problem that the developer regulating portion 7b1 of the developer layer thickness regulating member 7 digs into the surface layer 10 of the development roller 5 can be solved by the adjustment of the developer regulating portion 7b1 in the radius R of curvature.

The experiments were carried out in a high temperature/high humidity (H/H) environment, which was 35° C. in temperature and 90% in relative humidity (Rh). The results of the experiments were evaluated based on the same standard as that used for the evaluation of the results of the experiments carried out for the first verification. More concretely, three developer layer thickness regulating members 7 were prepared, which were 100 μm, 250 μm and 500 μm in the radius R of curvature of their developer regulating portion 7b1. In addition, two developer layer thickness regulating members, which were 0 μm and 700 μm in the radius R of curvature of their developer regulating portion 7b1, were prepared as comparative developer layer thickness regulating member 7. The five developer layer thickness regulating members 7 were measured in the amount, per unit area of the toner on their surface layer 10. When the amount per unit area of the toner on the surface layer of a given developer layer thickness regulating member 7 fell within a range of 0.35 m/cm²-0.55 mg/cm², the amount was recognized to be proper.

The results of the evaluation are shown in FIGS. 3(b) and 4. Referring to FIG. 4, when the straight developer layer thickness regulating member 7, that is, the developer layer thickness regulating member 7, the radius R of curvature of the developer regulating portion 7b1 of which is zero (R=0 μm), was used, none of the three development rollers, which are 15, 21 and 30 in the storage modulus E′ of their surface layer 10, respectively, could be coated with no less than 0.35 mg/cm² of toner. Further, when the developer layer thickness regulating member 7, the radius R of curvature of the developer regulating portion 7b1 of which was 700 μm, was used, the development roller 5 was coated with no less than 0.55 mg/cm². That is, the toner layer was improperly regulated in thickness.

On the other hand, when the developer layer thickness regulating members 7, the developer layer thickness regulating portion 7b1 of which is within a range of 100 μm-500 μm (100 82 m≦R≦500 μm), were used, the amount per unit area by which the toner was coated on the peripheral surface of the development roller 5 was no less than 35 mg/cm² and no more than 0.55 mg/cm². That is, the peripheral surface of the development roller 5 was coated with a proper amount of toner. Therefore, even a solid image, that is, an image which is 100% in print ratio was satisfactory in density. That is, when these developer layer thickness regulating members 7 were used, the peripheral surface of the development roller 5 were coated with a sufficient (proper) amount of toner per unit area. Therefore, these developer layer thickness regulating members 7 could prevent an image forming apparatus from outputting an image which is insufficient in density, even when the electrostatic latent image of an image which was high in print ratio was developed.

### <Verification 3>

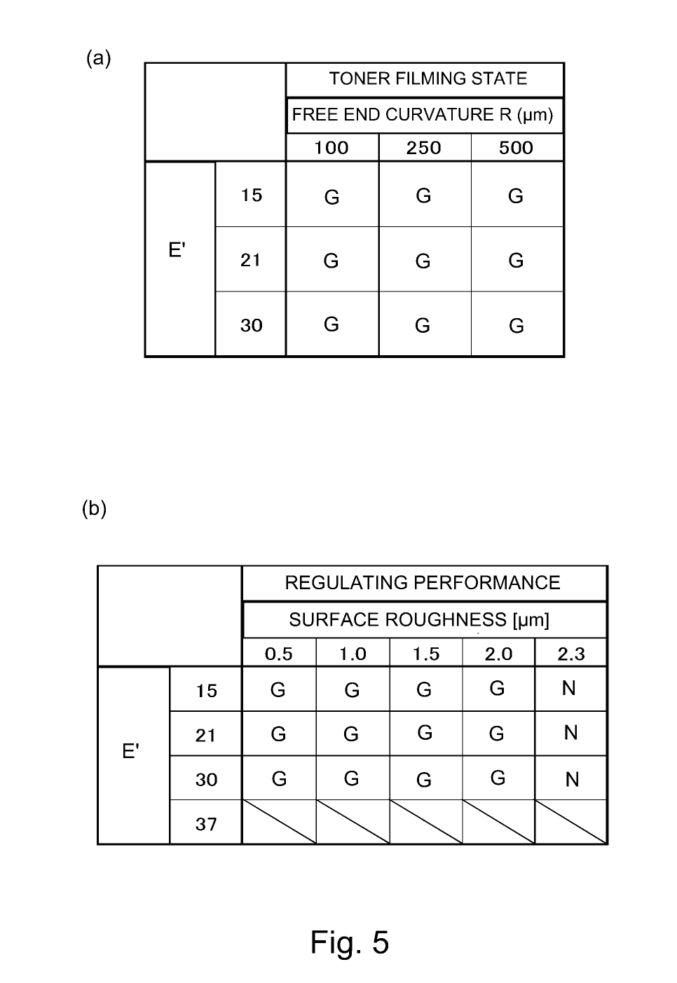

Next, referring to FIG. 5(a), the relationship between the radius R of curvature of the regulating portion 7b1 of the developer layer thickness regulating member 7, and the occurrence of the “toner filming” is described. The effectiveness of the present invention was verified through experiments carried out in low temperature/low humidity (L/L) environment which was 15° C. in temperature and 30% in relative humidity, that is, an environment in which the “toner filming” tends to occur. The developer layer thickness regulating members 7 used in the experiments were those, the developer thickness regulating portion 7b1 of which was 100 μm, 250 μm, and 500 μm in radius R of curvature, and which were verified to be effective. As for the development roller, three development rollers 5, the surface layer 10 of which was 15, 21 and 31 in storage E′, were used in combination with the abovementioned developer layer thickness regulating members 7 to find out whether or not the “toner filming” occurs. The verification method was the same as the first verification method.

FIG. 5(a) shows the results of the verification. “G” means that the “toner filming” did not occur. That is, in this case, the “toner filming” did not occur to the surface layer 10 of the development roller 5, regardless of the combinations between the three development rollers 5, the surface layer 10 of which is 15, 21 and 30, respectively, in storage E′ and the three developer layer thickness regulating members 7, the regulating portion 7b1 of which is 100 μm, 250 μm and 500 μm, respectively, in radius R of curvature.

The “toner filming” did not occur even in the low temperature/low humidity (L/L) environment which tends to cause the “toner filming”. In other words, a developer layer thickness regulating member, the radius R of curvature of the regulating portion 7b1 of which is within a range of 100 μm-500 μm is unlikely to cause the “toner filming” to the surface layer 10 of the development roller 5 even in a high temperature/high humidity (H/H) environment which was 35° C. in temperature and 90% in relative humidity Rh. That is, it is evident from FIG. 5(a) that the developer layer thickness regulating member in accordance with the present invention can coat the surface layer 10 of a development roller with a proper amount of toner per unit area, while preventing the occurrence of the “toner filming” to the surface layer 10 of the development roller 5, whether an image forming apparatus is operated in a low temperature/low humidity (L/L) environment or a high temperature/high humidity (H/H) environment.

Further, the studies of the results of the experiments revealed the following: providing the regulating portion 7b1 of a developer layer thickness regulating member 7 with a preset amount of curvature causes toner to temporally collect between the curved toner regulating portion 7b1 of the development layer thickness regulating member 7 and the surface layer 10 of a development roller 5. Consequently, it can prevent the formation of an image which suffers from a “development ghost” attributable to the nonuniformity of toner in terms of electrical charge.

### <Verification 4>

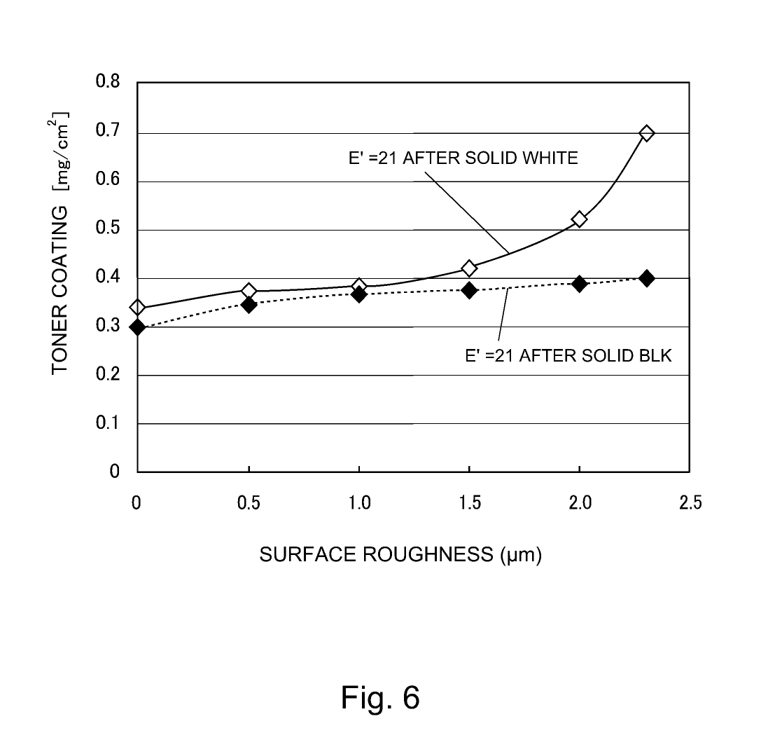

Next, referring to FIGS. 5(b) and 6, the relationship between the surface roughness Ra of the surface layer 10 of the development roller 5 and the amount by which toner is coated on the surface layer 10 of the development roller 5 is described. Referring to FIG. 5(b), “G” means that the amount by which the toner was coated was proper, and “N” means that amount by which the toner was coated was unsatisfactory. One of the possible methods for increasing the amount by which toner is coated on the surface layer 10 of the development roller 5 is to increase the surface layer 10 of the development roller 5 in surface roughness Ra. Thus, experiments were carried out to confirm the effects of the surface roughness Ra of the surface layer 10 of the development roller 5 upon the amount by which toner is coated on the surface layer 10.

The development rollers 5 used for the experiments were all 21 in the storage modulus E′ of their surface layer 10. The results of the experiments shows that the greater a development roller in the surface roughness Ra of its surface layer 10, the greater the amount by which the toner is coated on the surface layer 10 of the development roller 5 immediately after the formation of a solid “white” image. However, increasing the development roller 5 in the roughness R of its surface layer 10 did not increase the amount by which toner is coated on the surface layer 10 of the development roller 5 immediately after the formation a solid “black” image.

That is, not only did simply increasing the surface layer 10 of the development roller 5 in surface roughness Ra not ensure that the surface layer 10 was coated with a sufficient amount of toner immediately after the formation of a solid “black” image, but also, it increased the amount by which toner was coated on the surface layer 10 of the development roller 5 immediately after the formation of a solid “white” image.

Thus, fifteen development rollers 5 which are different (15, 21 and 30) in the storage modulus E′ of their surface layer 10, and also, in the surface roughness Ra (0.5 μm, 1.0 μm, 1.5 μm, 2.0 μm and 2.3 μm) of their surface layer 10 were tested using a straight developer layer thickness regulating member 7, that is, a developer layer thickness regulating member 7, the regulating portion 7b1 of which was 0 in radius R of curvature.

These development rollers 5 were tested for durability by being used for continuously outputting 20,000 prints covered with horizontal lines (1% in image ratio). The results of the test are shown in FIG. 5(b).

Referring to FIG. 5(b), the development rollers 5, the surface layer 10 of which was 2.3 μm (Ra=2.3 μm) in surface roughness Ra failed to be properly regulated in thickness the toner layer on their surface layer 10. In comparison, development rollers 5, which were no more than 0.5 in the roughness R of their surface layer 10 failed to be coated with a proper amount of toner immediately after the formation of a solid black image. The development rollers 5, the surface layer 10 of which was 2.0 μm in surface roughness Ra, were not improperly regulated in terms of the thickness of the toner layer on their surface layer 10. That is, their surface layer 10 was coated with a proper amount of toner.

Increasing the surface layer 10 of the development roller 5 in surface roughness Ra increases the surface layer 10 of the development roller 5 in the amount by which toner particles are packed into the numerous minute recesses in the surface of its surface layer 10. Thus, it halves the effect of softening of the surface layer 10 of the development roller 5. In addition, the studies of the results of the experiments revealed that increasing the surface layer 10 of the development roller 5 in surface roughness Ra causes the developer to be insufficiently charged, which in turn adversely affects an image forming apparatus in terms of the background fog, which is attributable to the toner transfer onto the portion of the peripheral surface of the photosensitive drum 1, which corresponds to the background portion of an image to be formed, that is, the portion of the peripheral surface of the photosensitive drum 1, to which developer (toner) is not to be transferred. Thus, it is desired that the surface roughness Ra of the surface layer 10 of the development roller 5 is in a range of 0.5 μm-2.0 μm (0.5 μm≦Ra≦2.0 μm).

The effect of the amount of the horizontal intrusion of the developer layer thickness regulating member 7 into the surface layer 10 of the development roller 5 was studied. In terms of the effect upon the amount by which toner is coated on the surface layer 10 of the development roller 5, the curvature of the developer layer thickness regulating portion 7b1 of the developer layer thickness regulating member 7 was dominant. That is, the theory that the amount by which toner is coated on the surface layer 10 of the development roller 5 can also be increased by increasing the amount of horizontal intrusion of the developer layer thickness regulating member 7 into the surface layer 10 of the development roller 5, was proved to be wrong.

### <Verification 5>

Based on the results given above, development rollers 5, the storage modulus E′ of the surface layer 10 of which was in a range of 15-30 (15≦E′≦30), and the surface roughness Ra of the surface layer 10 of which was in a range of 0.5 μm-2.0 μm (0.5 μm≦Ra≦2.0 μm) were prepared. Further, developer layer thickness regulating members 7, the radius R of the developer regulating portion 7b1 of which was in a range of 100 μm-500 μm (100 μm≦R≦500 μm), were prepared. These development rollers 5 and developer layer thickness regulating members 7 were attached in various combinations to the developing device 6, to be tested in a low temperature/low humidity (L/L) environment, more specifically, an environment which was 15° C. in temperature and 30% in relative humidity (Rh), and also, in a high temperature/high humidity (H/H) environment, which was 35° C. in temperature and 90% in relative humidity (Rh).

In an endurance test in which 20,000 images which are made up of multiple horizontal lines and is 1% in image ratio were continuously outputted, not only did “toner filming” not occur, but also, all images were satisfactory in terms of the solid image density.

### (Summary)

As described above, in order to prevent the occurrence of the “toner filming”, the amount of load (stress) to which toner is subjected is reduced by employing a development roller 5 having a softer surface layer 10, that is, a surface layer 10, the storage modulus E′ of which is in a range of 15-30 (15≦E′≦30). However, the surface layer 10, the storage modulus E′ of which is in the above described range is soft enough to allow the developer layer thickness regulating member 7 to dig into the surface layer 10. Thus, the developer regulating portion 7b1 of the developer layer thickness regulating member 7 is provided with a curvature, the radius R of curvature of which is in a range of 100 μm-500 μm (100 μm≦R≦500 μm). Thus, even if the developer layer thickness regulating member 7 digs into the surface layer 10, the curved portion of the developer regulating portion 7 allows toner to enter the gap between the developer layer thickness regulating member 7 and development roller 5 by a sufficient amount. Therefore, the development roller 5 is enabled to bear a sufficient amount of toner. Therefore, even if the developer layer thickness regulating member 7 digs into the surface layer 10 of the development roller 5, the image forming apparatus is prevented from reducing in image density.

Incidentally, the developer layer thickness regulating member 7, developer bearing member (development roller 5), and developer (toner) in this embodiment are examples which are in accordance with the present invention. That is, the present invention is also applicable to a developer layer thickness regulating member 7, a developer bearing member (development roller 5), and developer (toner), which are different from those in the this embodiment, and the effects of the application are the same as those described above, as long as the storage modulus E′ of the surface layer of the development roller 5, and the curvature of the developer layer regulating portion of the developer layer thickness regulating member 7 are within the above described ranges. Further, in this embodiment, the developer regulating portion of the developer layer thickness regulating member 7 was formed of electrically conductive substance, for example. However, the material for the regulating portion of the developer layer thickness regulating member 7 has little influence upon the effectiveness of the present invention. Thus, the regulating portion of the developer layer thickness regulating member 7 may be formed of a substance other than an electrically conductive resin. Further, the sphericity of toner, and the type of external toner additive, have also little influence upon the effectiveness of the present invention. That is, the present invention is also compatible with toner which is different in sphericity from the toner used in the developing device 6 in this embodiment, and the external toner additive which is different from those in the toner used by the developing device 6 in this embodiment.

As will be evident from the detailed description of this embodiment, the present invention can enable a developing device to make its developer bearing member to bear a proper amount of toner while preventing the occurrence of the “toner filming”.

While the invention has been described with reference to the structures disclosed herein, it is not confined to the details set forth, and this application is intended to cover such modifications or changes as may come within the purposes of the improvements or the scope of the following claims.

This application claims priority from Japanese Patent Applications Nos. 061724/2012 and 011989/2013 filed Mar. 19, 2012 and Jan. 25, 2013, respectively which are hereby incorporated by reference.

What is claimed is:

1. A developing apparatus for an image forming apparatus, said developing apparatus comprising:
a developer carrying member for carrying a developer to develop an electrostatic latent image formed on an image bearing member; and
a regulating member contacted to said developer carrying member to regulate a layer thickness of the developer on said developer carrying member,
wherein said developer carrying member includes a surface layer having a storage modulus E′ satisfying 15 Pa≦E′≦30 Pa, said regulating member includes an free end having a curved surface to define a space with said surface layer to provide an entrance for the developer, and said curved surface has a radius of curvature R satisfying 100 μm≦R≦500 μm.

2. An apparatus according to claim 1, wherein said surface layer has a surface roughness Ra satisfying 0.5 μm≦Ra≦2.0 μm.

3. An apparatus according to claim 1, wherein the free end of the regulating member is made of electroconductive resin material.

4. An apparatus according to claim 1, wherein the free end of the regulating member is made of an elastomer.

5. An apparatus according to claim 1, wherein said regulating member is made of a metal, which is bent adjacent the free end.

6. An apparatus according to claim 1, wherein said regulating member is contacted to said developer carrying member at a line pressure P satisfying 0.1 N/cm≦P≦0.4 N/cm.

7. An apparatus according to claim 1, wherein said regulating member has a flat surface portion contacted to said developer carrying member.

8. An apparatus according to claim 1, wherein said developer carrying member includes a shaft, an electroconductive elastic layer of a material different from that of said surface layer at an outer periphery of the shaft, wherein said surface layer is electroconductive and is provided at an outer periphery of said elastic layer.

9. A process cartridge detachably mountable to a main assembly of an image forming apparatus, said process cartridge comprising:
an image bearing member for bearing a latent image;
a developer carrying member for carrying a developer to develop an electrostatic latent image formed on said image bearing member; and
a regulating member contacted to said developer carrying member to regulate a layer thickness of the developer on said developer carrying member,
wherein said developer carrying member includes a surface layer having a storage modulus E′ satisfying 15 Pa≦E′≦30 Pa, said regulating member includes an free end having a curved surface to define a space with said surface layer to provide an entrance for the developer, and said curved surface has a radius of curvature R satisfying 100 μm≦R≦500 μm.

10. A process cartridge according to claim 9, wherein said surface layer has a surface roughness Ra satisfying 0.5 μm≦Ra≦2.0 μm.

11. A process cartridge according to claim 1, wherein the free end of the regulating member is made of electroconductive resin material.

12. A process cartridge according to claim 9, wherein the free end of the regulating member is made of an elastomer.

13. A process cartridge according to claim 9, wherein said regulating member is made of a metal, which is bent adjacent the free end.

14. A process cartridge according to claim 9, wherein said regulating member is contacted to said developer carrying member at a line pressure P satisfying 0.1 N/cm≦P≦0.4 N/cm.

15. A process cartridge according to claim 9, wherein said regulating member has a flat surface portion contacted to said developer carrying member.

16. An image forming apparatus for forming an image on a recording material, said image forming apparatus comprising:
an image bearing member for bearing a latent image;
a developer carrying member for carrying a developer to develop an electrostatic latent image formed on an image bearing member;
a regulating member contacted to said developer carrying member to regulate a layer thickness of the developer on said developer carrying member; and
a feeding device for feeding the recording material,
wherein said developer carrying member includes a surface layer having a storage modulus E′ satisfying 15 Pa≦E′≦30 Pa, said regulating member includes a free end having a curved surface to define a space with said surface layer to provide an entrance for the developer, and said curved surface has a radius of curvature R satisfying 100 μm≦R≦500 μm.

17. An apparatus according to claim 16, wherein said surface layer has a surface roughness Ra satisfying 0.5 μm≦Ra≦2.0 μm.

18. An apparatus according to claim 16, wherein the free end of the regulating member is made of electroconductive resin material.

19. An apparatus according to claim 16, wherein the free end of the regulating member is made of an elastomer.

20. An apparatus according to claim 16, wherein said regulating member is made of a metal, which is bent adjacent the free end.
